(19) United States
(12) Patent Application Publication
(10) Pub. No.: US 2006/0224380 A1
(43) Pub. Date: Oct. 5, 2006

(54) Pitch pattern generating method and pitch pattern generating apparatus

(76) Inventors: Gou Hirabayashi, Kawasaki-shi (JP); Takehiko Kagoshima, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/385,822

(22) Filed: Mar. 22, 2006

(30) Foreign Application Priority Data
Mar. 29, 2005 (JP) 2005-095923
Feb. 16, 2006 (JP) 2006-039379

(51) Int. Cl. G10L 11/04

(52) U.S. Cl. 704/207

(57) ABSTRACT

A pitch pattern generating method includes preparing a memory to store a plurality of pitch patterns each extracted from natural speech, and pattern attribute information corresponding to the pitch patterns, inputting language attribute information obtained by analyzing a text including prosody control units, selecting, from the pitch patterns stored in the memory, a group of pitch patterns corresponding to each of the prosody control units based on the language attribute information, to obtain a plurality of groups corresponding to the prosody control units respectively, generating a new pitch pattern corresponding to the each of prosody control units by fusing pitch patterns of the group, to obtain a plurality of new pitch patterns corresponding to the prosody control units respectively, and generating a pitch pattern corresponding to the text based on the new pitch patterns.

### CROSS-REFERENCE TO RELATED APPLICATIONS

This application is based upon and claims the benefit of priority from prior Japanese Patent Applications No. 2005-095923, filed Mar. 29, 2005; and No. 2006-039379, filed Feb. 16, 2006, the entire contents of both of which are incorporated herein by reference.

### BACKGROUND OF THE INVENTION

1. Field of the Invention

The present invention relates to a pitch pattern generating method and a pitch pattern generating apparatus for speech synthesis.

2. Description of the Related Art

Recently, development has been and is in progress for the provision of text-to-speech synthesis systems that performs artificial generation of speech signals from arbitrary sentences. Generally, a text-to-speech synthesis system includes three modules; namely, a language processing unit, a prosody generating unit, and a speech signal generating unit. In these modules, the performance of the prosody generating unit relates to naturalness of synthesized speech. In particular, the naturalness of synthesized speech is affected greatly by a pitch pattern generating methods which is a pattern representing a changing of pitch levels of speech. In conventional pitch pattern generating methods in text-to-speech synthesis, pitch patterns are generated by relatively simple models, such that the synthesized speech is generated with unnatural mechanical intonation.

In order to solve problems as described above, an approach or method has been proposed that uses pitch patterns extracted from natural speech (See Jpn. Pat. Appln. KOKAI No. 11-95783, for example). According to the method, the representative patterns per accent phrase, which are typical patterns extracted by use of a statistical method, are stored in advance, and each representative pattern selected corresponding to a respective accent phrase are transformed and concatenated together, thereby to generate a pitch pattern.

In addition, a method has been proposed that does not generate representative patterns, but utilizes a large number of pitch patterns as they are extracted from natural speech (see Jpn. Pat. Appln. KOKAI No. 2002-297175, for example). According to the method, pitch patterns extracted from natural speech are stored in a pitch pattern database in advance. A pitch pattern is generated by selecting an optimal pitch pattern from the pitch pattern database based on language attribute information corresponding to a text being input.

According to the pitch pattern generating method using the representative pattern, it is difficult to apply the method to various types of input text since limited representative patterns are pre-generated. Thereby, detailed pitch changing due to, for example, phoneme environment, cannot be represented, such that the naturalness of synthesized speech is deteriorated.

According to the method using the pitch pattern database, on the other hand, the pitch information of natural speech is used. For this reason, pitch patterns with high naturalness can be generated inasmuch as long as a pitch pattern matching with an input text can be selected from the pitch pattern database. Nevertheless, however, it is difficult to establish rules for selecting pitch patterns subjectively naturally perceptible from, for example, input language attribute information corresponding to the input text. Therefore, the method causes the problem of deteriorating the naturalness of synthesized speech because a single pitch pattern finally selected as an optimal pitch pattern in conformity with rules is subjectively inappropriate. In addition, in the case where the number of pitch patterns in the pitch pattern database is large, it is difficult to pre-eliminate defective patterns by performing pre-checking of all the pitch patterns. As such, an additional problem arises in that a defective pattern is unexpectedly mixed into the selected pitch patterns, thereby causing quality deterioration of the synthesized speech.

### BRIEF SUMMARY OF THE INVENTION

According to embodiments of the present invention, a pitch pattern generating method includes: preparing a memory to store a plurality of pitch patterns each extracted from natural speech, and pattern attribute information corresponding to the pitch patterns; inputting language attribute information obtained by analyzing a text including prosody control units; selecting, from the pitch patterns stored in the memory, a group of pitch patterns corresponding to each of the prosody control units based on the language attribute information, to obtain a plurality of groups corresponding to the prosody control units respectively; generating a new pitch pattern corresponding to the each of prosody control units by fusing pitch patterns of the group, to obtain a plurality of new pitch patterns corresponding to the prosody control units respectively; and generating a pitch pattern corresponding to the text based on the new pitch patterns.

### BRIEF DESCRIPTION OF THE SEVERAL VIEWS OF THE DRAWING

FIG. 1 is a diagram showing an example of a configuration of a text-to-speech synthesis system according to an embodiment of the present invention;

FIG. 2 is a diagram showing an example of a configuration of a pitch pattern generating unit of the embodiment;

FIG. 3 is a view showing an example of attribute information of each pitch pattern stored in a pitch pattern storing unit of the embodiment;

FIG. 4 is a flowchart showing an example of a processing procedure of the pitch pattern generating unit;

FIG. 5 is a flowchart showing an example of a processing procedure of a pattern fusing unit of the embodiment;

FIG. 6 are a view descriptive of a method of a process of scaling (expanding and/or contracting) the lengths of a plurality of pitch patterns;

FIG. 7 is a view descriptive of a method of a process of generating a new pitch pattern by fusing a plurality of pitch patterns;

FIG. 8 is a view descriptive of a method of processes of a pattern scaling unit and an offset control unit of the embodiment; and

FIG. 9 is a diagram showing an example of a configuration of a pitch pattern generating unit according to another embodiment of the invention.

### DETAILED DESCRIPTION OF THE INVENTION

Embodiments of the present invention will be described herebelow with reference to the accompanying drawings.

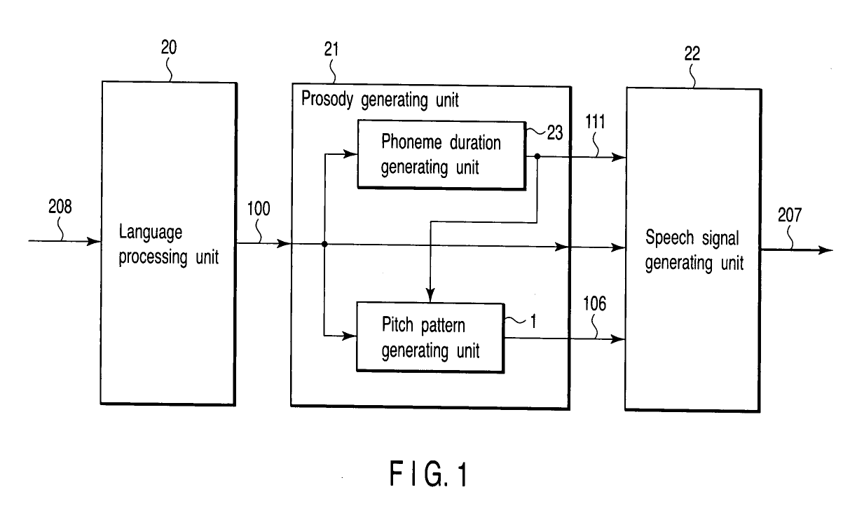

FIG. 1 shows an example of a configuration of a text-to-speech synthesis system according to one embodiment of the present invention.

With reference to FIG. 1, the text-to-speech synthesis system includes a language processing unit 20, a prosody generating unit 21, and a speech signal generating unit 22. The prosody generating unit 21 includes a phoneme-duration generating unit 23 (duration generating unit 23) that generates duration of each phoneme, and a pitch pattern generating unit 1 that generates pitch patterns (each of which represents temporal variation in pitch that is one of prosodic characteristics of speech).

When, in the text-to-speech synthesis system shown in FIG. 1, text (208) is inputted, language processes (such as morphological analysis and syntax analysis) are performed on the text (208) by the language processing unit 20, whereby language attribute information (100) (including, for example, phoneme symbol string, accent position, grammatical part of speech, and position in a sentence or the like) is acquired and outputted.

Subsequently, the prosody generating unit 21 generates information representing prosodic characteristics of speech corresponding to the text (208).The information being generated by the prosody generating unit 21 include, for example, phoneme-duration, pattern representing temporal variation in fundamental frequency (pitch), and so on.

More specifically, in the embodiment, the duration generating unit 23 of the prosody generating unit 21 refers to the language attribute information (100), thereby to generate and output duration (111) of the respective phoneme. In addition, the pitch pattern generating unit 1 of the prosody generating unit 21 refers to the language attribute information (100) and the duration (111), and thereby outputs a pitch pattern (206) representing a change pattern of height of voice.

Then, the speech signal generating unit 22 synthesize speech corresponding to the text (208) based on the prosodic information generated by the prosody generating unit 21, and outputs a synthesized speech in the form of a speech signal (207).

The following describes the present embodiment in more detail by focusing on the configuration of the pitch pattern generating unit 1 and processing operation thereof.

Description will be provided with reference to an example case in which the unit of prosody control is the accent phrase.

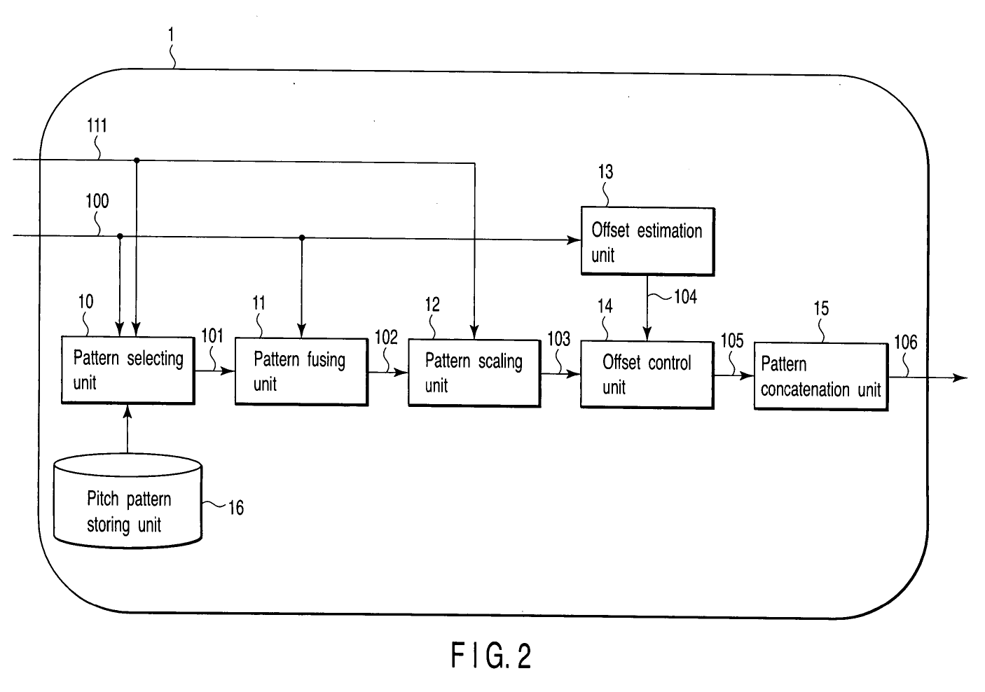

FIG. 2 shows an example of an interior configuration of the pitch pattern generating unit 1.

Referring to FIG. 2, the pitch pattern generating unit 1 includes a pattern selecting unit 10, a pattern fusing unit 11, a pattern scaling unit 12, an offset estimation unit 13, an offset control unit 14, a pattern concatenating unit 15, and a pitch pattern storing unit 16.

The pitch pattern storing unit 16 stores a plurality (preferably, a large number) of pitch patterns each corresponding to accent phrase and being extracted from natural speech, and stores pattern attribute information corresponding to respective pitch patterns.

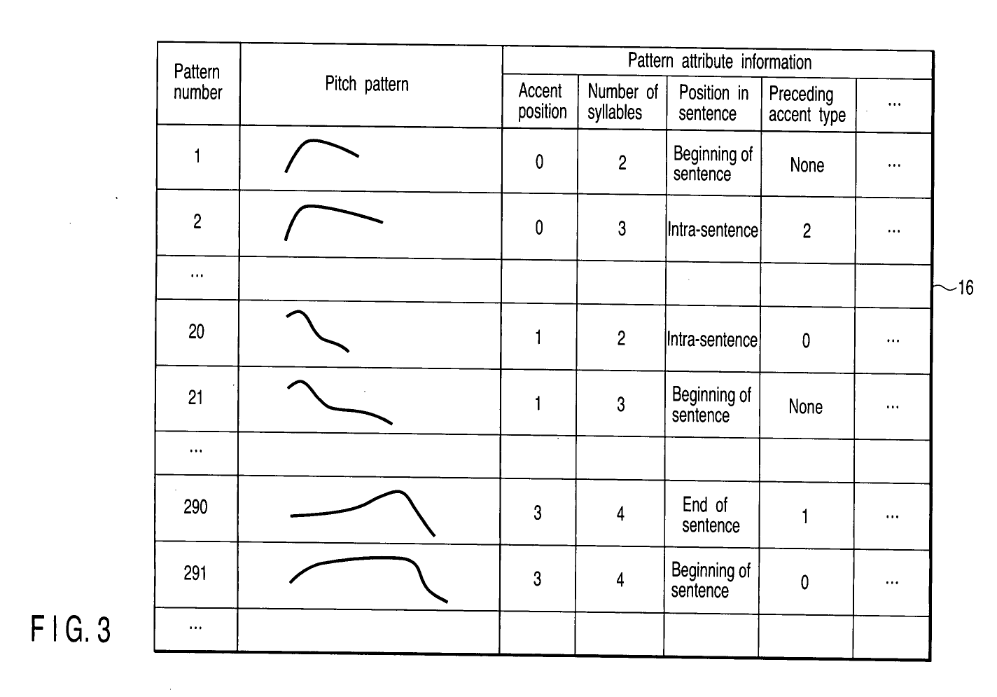

FIG. 3 is a view showing an example of information stored in the pitch pattern storing unit 16. Referring to the example shown in FIG. 3, one of pitch pattern information stored in the pitch pattern storing unit 16 includes a pattern number, a pitch pattern, and pattern attribute information.

The pitch pattern is a pitch sequence representing temporal variation in pitch corresponding to the accent phrase or a parameter sequence representing the characteristics of temporal variation in pitch. While there is no pitch in an unvoiced portion, it is preferable that the pitch pattern takes the form of a continuous sequence formed by, for example, interpolating the unvoiced portion by using pitch values of voiced portion.

The pitch pattern storing unit 16 stores each pitch pattern extracted from natural speech as is.

Alternatively, the pitch pattern storing unit 16 stores each quantized pitch pattern which is the quantization result of each pitch pattern by using vector quantization technique with pre-generated codebook.

Still alternatively, the pitch pattern storing unit 16 stores each approximated pitch pattern which is the result of function approximation (such as approximation by, for example, the Fujisaki model as the production model of pitch) of each pitch pattern extracted from the natural speech.

The pattern attribute information includes all or some of information items, such as the accent position, the number of syllables, position in sentence, and preceding accent position, and information other than the above.

The pattern selecting unit 10 selects from pitch patterns stored in the pitch pattern storing unit 16, a plurality of pitch patterns (101) per accent phrase based on the language attribute information (100) and the phoneme duration (111).

The pattern fusing unit 11 fuses a plurality of pitch patterns (101) being selected by the pattern selecting unit 10, based on the language attribute information (100), and then generates a new pitch pattern (102).

The pattern scaling unit 12 scales (expand/contract) each pitch pattern (102) in time domain based on the duration (111), and thereby generates pitch pattern (103).

The offset estimation unit 13 estimates, from the language attribute information (100), an offset value (104) which is an average height (or level) of the overall pitch pattern each corresponding to accent phrase, and outputs the offset value (104) being estimated. The offset value (104) is information representing the overall pitch level of the pitch pattern corresponding to a respective prosody control unit (accent phrase in the present embodiment). More specifically, the offset value represents, for example, an average height of the patterns, a maximum pitch or minimum pitch of the patterns, and variation from the preceding or subsequent pitch pattern. For the estimation of the offset value, a well-known statistical method, such as the quantification method of the first type (“quantification method type I” hereafter), may be employed.

The offset control unit 14 moves the pitch patterns (103) parallel to the frequency axis based on the estimated offset value (104) (i.e., transformation based on the offset value that represents level of the pitch pattern), and outputs pitch patterns being transformed (105).

The pattern concatenating unit 15 concatenates together the pitch patterns (105) each being generated every accent phrase, and performs processing, such as smoothing processing, to prevent occurrence of discontinuity in concatenation boundary portions, thereby to output a sentence pitch pattern (106).

Processing of the pitch pattern generating unit 1 will now be described herebelow.

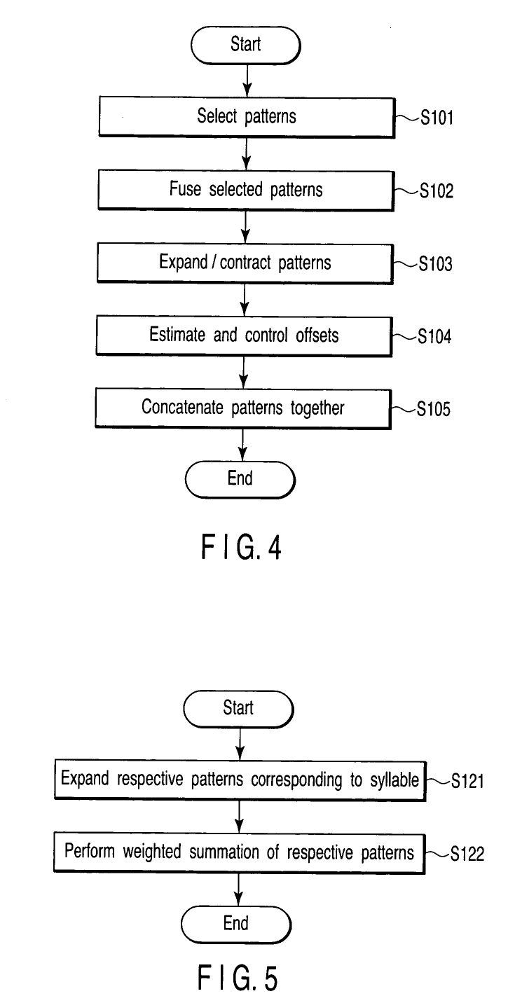

FIG. 4 shows an example of a processing procedure to be executed by the pitch pattern generating unit 1.

To begin with, in step S101, based on the language attribute information (100), the pattern selecting unit 10 selects from the pitch patterns stored in the pitch pattern storing unit 16, the plurality of pitch patterns (101) per accent phrase.

The pitch patterns (101) being selected every accent phrase whose pattern attribute information matches with or are similar to the language attribute information (100) corresponding to the accent phrase. In this case, the pattern selecting unit 10 estimates (calculates) from the language attribute information (100) corresponding to the target accent phrase and the pattern attribute information of each pitch pattern stored in the pitch pattern storing unit 16, a cost which is a value representing the degrees of difference between a desired pitch pattern and the pitch patterns stored in the pitch pattern storing unit 16. And pattern selecting unit 10 selects a pitch pattern whose cost is lowest of the costs being obtained. As an example, it is now assumed that N pitch patterns with low costs are selected from the pitch patterns having the pattern attribute information that matches with one another in the “accent position” and “number of syllables” of the target accent phrase.

The cost estimation may be executed by calculating the cost function similar to one in conventional text-to-speech synthesis systems, for example. More specifically, for example, the sub-cost functions

Cₙ(uᵢ, uᵢ₋₁, tᵢ) (n=1 to M; M is the number of sub-cost functions) are defined for each factor causing difference in pitch pattern shape or for each factor causing distortion occurring when pitch patterns are transformed or concatenated with one another, and an equation (1) is defined as shown below with the weighted sum being used as accent phrase cost functions.
C(uᵢ, uᵢ₋₁, tᵢ)=ΣwₙCₙ(uᵢ, uᵢ₋₁, tᵢ) (1)

In this case, a total summation range of the wₙCₙ(uᵢ, uᵢ₋₁, tᵢ) is n=1 to M (n is a positive number).

The variable tᵢ represents desired (target) language attribute information of pitch pattern corresponding to an i-th accent phrase when desired pitch patterns corresponding to an input text and language attribute information are set as t=(tᵢ, . . . , t_{I}). The variable uᵢ represents pattern attribute information of one pitch pattern selected from the pitch patterns stored in the pitch pattern storing unit 16. The variable Wₙ represents the weight of each sub-cost function.

The sub-cost function is used to calculate the cost for estimating the degree of difference between the desired pitch pattern and each of the pitch patterns stored in the pitch pattern storing unit 16. In the present case, two types of sub-costs, namely, a target cost and a concatenation cost are set. The target cost is set to estimate the degree of difference to the desired pitch pattern, the difference occurring by using the pitch pattern stored in the pitch pattern storing unit 16. The concatenation cost is set to estimate the degree of distortion occurring when the pitch pattern of an accent phrase is concatenated with another pitch pattern of another accent phrase.

As an example of the target cost, a sub-cost function regarding the position in sentence of the language attribute information and the language attribute information can be defined as in equation (2) below.
C₁(uᵢ, uᵢ₋₁, tᵢ)=δ(f(uᵢ), f(tᵢ)) (2)

In this case, the notational expression “f( )” represents either pattern attribute information of pitch pattern stored in the pitch pattern storing unit 16 or a function for retrieving information regarding the position in sentence from the target language attribute information. The notational expression “δ( )” is a function for outputting “0” when the two information item match with one another or for outputting “1” in the other event.

As an example of the concatenation cost, a sub-cost regarding pitch differences at a concatenation boundary can be defined as in equation (3) below.
C₂(uᵢ, uᵢ₋₁, tᵢ)={g(uᵢ) g(uᵢ₋₁)}² (3)

In this case, the notification expression “g( )” represents a function for retrieving the pitch at the concatenation boundary from the pattern attribute information.

A “cost” refers to the sum of the results of calculations of accent phrase costs corresponding, respectively, to the accent phrase of the input text for all accent phrases, and a function for calculating the cost is defined as in equation (4) below.
Cost=ΣC(uᵢ, uᵢ₋₁, tᵢ) (4)

In this case, a total summation range of the C(uᵢ, u_{i-1, t}ᵢ) is i=1 to I (i is a positive number).

A plurality of pitch patterns per accent phrase are selected in two stages from the pitch pattern storing unit 16 by using the cost functions shown in the equations (1) to (4).

To begin with, in order for pitch pattern selection in the first stage, a sequence of pitch patterns minimizing the cost value being calculated by the equation (4) is searched for from the pitch pattern storing unit 16. A combination of pitch patterns thus minimizing the cost, herebelow, will be referred to as an “optimal pitch pattern sequence”. An optimal pitch pattern sequence can be efficiently searched for by using dynamic programming.

For pitch pattern selection in the second stage, a plurality of pitch patterns for one accent phrase is selected by using the optimal pitch pattern sequence. A case is herein assumed in which I represents the number of accent phrases of an input text, and N pitch patterns (101) are selected for each accent phrase.

Processing below is performed such that one of the I accent phrases is set to be an target accent phrase, and the I accent phrases are each set one time to be a target accent phrase. First, the pitch patterns of the optimal pitch pattern sequence, respectively, are fixed to accent phrases other than the target accent phrase. In this state, pitch patterns stored in the pitch pattern storing unit 16 is ranked with respect to the target accent phrase, in order of the cost values obtained by the equation (4). In this case, for example, the lower is the cost of a pitch pattern, the higher is ranked the pitch pattern. Subsequently, top N pitch patterns are selected in accordance with the ranking.

The plurality of pitch patterns (101) are selected for each of the accent phrases from the pitch pattern storing unit 16 in accordance with the procedure described above.

Subsequently, in step S102, the pattern fusing unit 11 fuses a plurality of pitch patterns (101) selected by the pattern selecting unit 10, that is, the N pitch patterns being selected for one accent phrase based on the language attribute information (100), thereby to generate a new pitch pattern (102) (fused pitch pattern).

The following will now describe a processing procedure to fuse N pitch patterns selected by the pattern selecting unit 10, and to generate one new pitch pattern for each accent phrase.

FIG. 5 shows an example of a processing procedure in the case described above.

In step S121, the lengths of the respective syllables of each of the N pitch patterns are scaled to the longest one of the N pitch patterns by expanding patterns in the syllables.

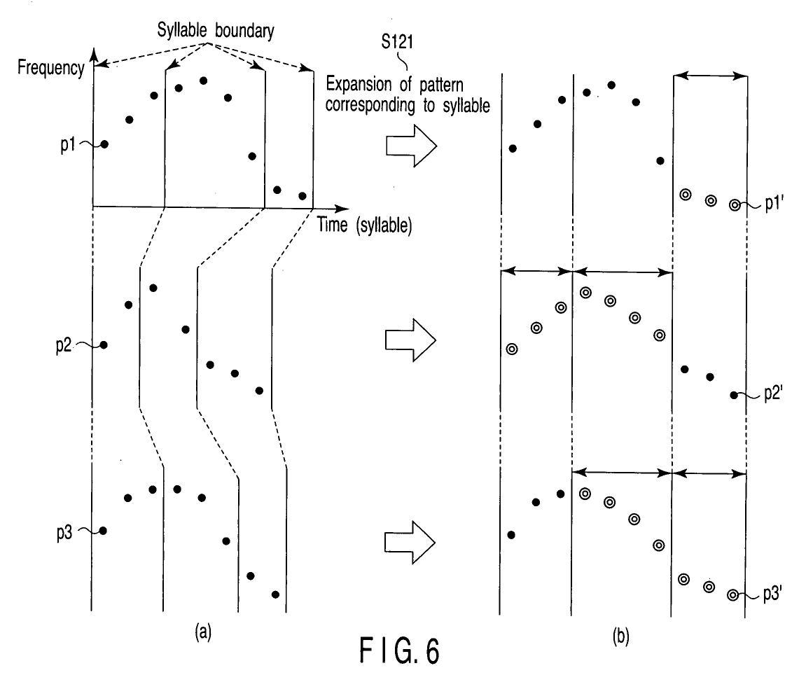

FIG. 6 show a procedure for generating pitch patterns P1′ to P3′ (see FIG. 6(b)) by scaling the length for respective syllables of each of respective N (for example, three in this case) pitch patterns P1 to P3 of the accent phrase (see FIG. 6(a)). In the example shown in FIG. 6, interpolation is carried out with data representing one syllable for expansion of the patterns in the syllables (see double circle portions of FIG. 6(b)).

Then, in step S122, new pitch pattern is generated by performing weighted summation of the length-scaled N pitch patterns. The weight can be set in accordance with the similarity in the language attribute information (100) corresponding to the respective accent phrase and in the pattern attribute information of the respective pitch pattern. In the example case, the weight is set by using the reciprocal of a cost Cᵢ, which has been calculated by the pattern selecting unit 10, for each pitch pattern Pᵢ. Preferably, the weight is set to a value greater for the pitch pattern whose cost is smaller and which is estimated to be appropriate with respect to the desired pitch variation. Accordingly, a weight wᵢ for each pitch pattern Pᵢ can be calculated from equation (5).
wᵢ=1/(Cᵢ×Σ(1/Cⱼ)) (5)

A total summation range of the (1/Cⱼ) is j=1 to N (j is a positive number).

The calculated weight is multiplied with the respective N pitch patterns, and the results are summated, thereby to generate a new pitch pattern.

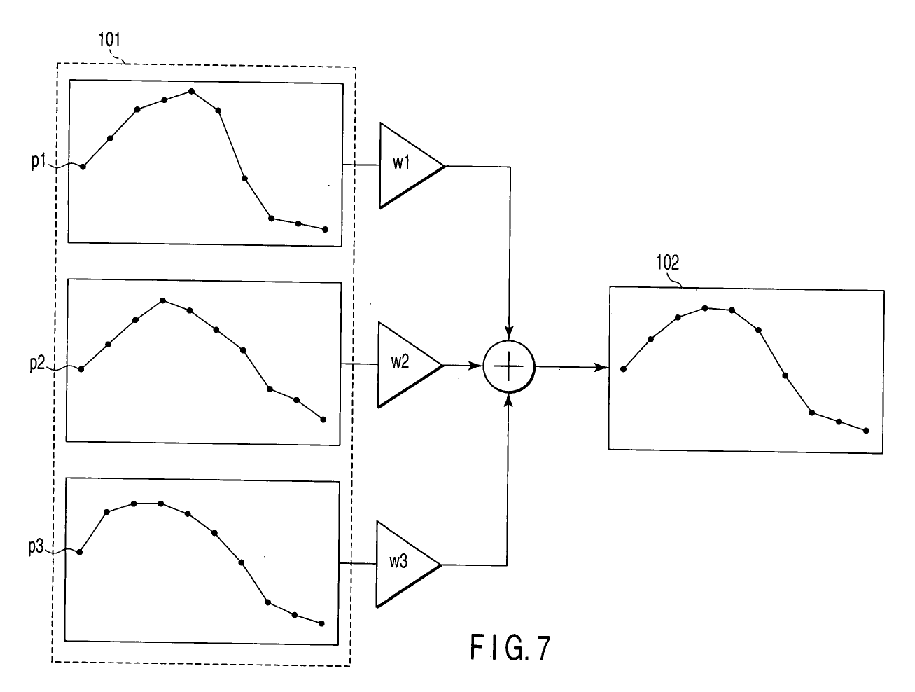

FIG. 7 shows the method for generating a new pitch pattern (102) by performing weighted summation of N pitch patterns (for example, three in the present case) of the accent phrase. In the FIG. 7, w1, w2, and w3, respectively, are weight values corresponding to pitch patterns p1, p2, and p3.

Thus, with respect to each of the plurality (I number) of accent phrases corresponding to the input text, the N pitch patterns selected for the accent phrase are fused, thereby to generate the new pitch pattern (102) (fused pitch pattern). Subsequently, the processing proceeds to step S103 in FIG. 4.

In step S103, the pattern scaling unit 12 performs expansion/contraction process on the pitch pattern (102) generated by the pattern fusing unit 11 by expanding or contracting the pitch pattern in the time domain based on the duration (111), thereby to generate the pitch pattern (103).

Subsequently, in step S104, the offset estimation unit 13 first estimates an offset value (104) equivalent to an average height of the allover pitch patterns from the language attribute information (100) corresponding to the respective accent phases using a statistical method, such as quantification method type I. The offset control unit 14 moves the pitch patterns (103) parallel to the frequency axis, based on the estimated offset value (104). Thereby, average pitch of the respective accent phrases are regulated to the estimated offset values (104) for the respective accent phrases, and the pitch pattern (105) resultantly acquired are outputted.

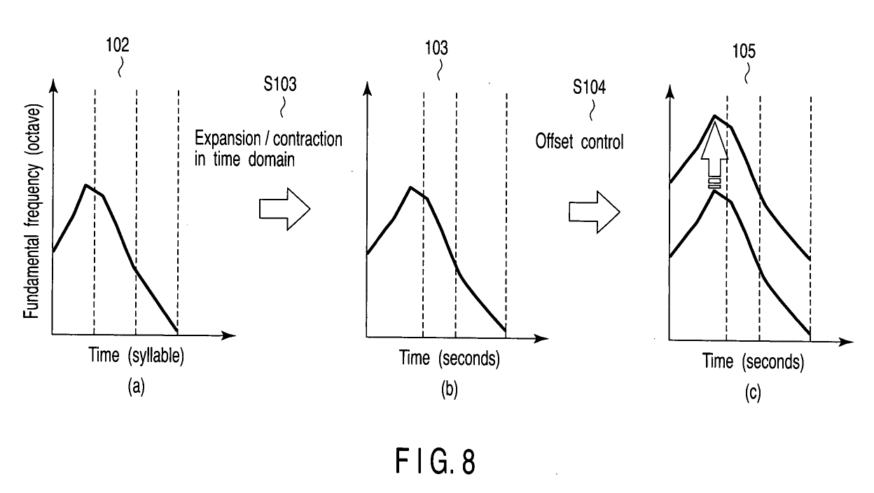

FIG. 8 shows examples of processes of steps S103 and S104. More specifically, FIG. 8(a) shows an example pitch pattern before the process of step S103; FIG. 8(b) shows the pitch pattern before the process of step S104; and FIG. 8 shows the pitch pattern after the process of step S104.

Then, in step S105, the pattern concatenating unit 15 concatenates together the pitch patterns (105) generated for the respective accent phrases, and generates a sentence pitch pattern (106), which is one of the prosodic characteristics of the speech corresponding to the input text (208). In addition, when the pitch patterns (105) of the respective accent phrases are concatenated with one another, processing such as smoothing processing is performed to prevent occurrence of discontinuity in concatenation boundary portions of the accent phrases, and a sentence pitch pattern (106) is outputted.

As described above, according to the present embodiment, based on language attribute information corresponding to an input text, a plurality of pitch patterns are selected corresponding to the each prosody control unit by the pattern selecting unit 10 from the pitch pattern storing unit 16 storing the large number of pitch patterns extracted from natural speech. In the pattern fusing unit 11, a plurality of pitch patterns selected corresponding to the each prosody control unit are fused to thereby generate the new fused pitch pattern. As such, pitch patterns corresponding to the input text and even more similar to pitch variation of human-uttered speech can be generated. Consequently, speech voice having high naturalness can be synthesized. Further, even in a case where an optimal pitch pattern cannot be selected with the highest rank in the pattern selecting unit 10, speech voice having high naturalness and even more stability can be synthesized by generating a fused pitch pattern from a plurality of appropriate pitch patterns. As a consequence, synthesized speech even more similar to human-uttered speech can be generated by use of such pitch patterns.

The pattern attribute information corresponding to each pitch pattern stored in the pitch pattern storing unit 16 is a group of attributes related to the each pitch pattern. The attributes are, but not limited to, the accent position, number of syllables, position in sentence, accented phoneme type, preceding accent position, succeeding accent position, preceding boundary condition, and succeeding boundary condition.

The prosody control unit is the unit for controlling the prosodic characteristics of speech corresponding to an input text, and may be components, such as phoneme, semi-phoneme, syllable, morpheme, word, accent phrase, and expiratory segment, or may be of a variable length with a mixture of those components.

The language attribute information is information item extractable from the input text by performing language analysis processes such as morphological analysis and syntax analysis, and includes, for example, phoneme symbol string, grammatical part of speech, accent position, syntactic structure, pause, and position in sentence.

Fusing of pitch patterns is the operation for generating a new pitch pattern from a plurality of pitch patterns in accordance with a rule, and is accomplished by performing, for example, a weighted summation process of a plurality of pitch patterns.

A plurality of pitch patterns each corresponding to the respective prosody control unit of a text being input as a target text of speech synthesis are selected from storing unit, the selected pitch patterns are fused. Thereby, one respective new pitch pattern is generated corresponding to the respective prosody control unit, and a pitch pattern corresponding to the target text is generated based on the respective new fused pitch pattern. Accordingly, a pitch pattern having high naturalness and even more stability can be generated. And synthesized speech even more similar to human-uttered speech can be generated by use of such pitch patterns.

In the embodiment described above, the weights being used for fusing the pitch patterns are defined as the functions of the cost values in step S122 in FIG. 5, but the manner is not limited thereto. For example, such an alternative manner can be contemplated in which a centroid of the plurality of pitch patterns (101) selected by the pattern selecting unit 10 is calculated, and each weight corresponding to each of the pitch patterns (101) is determined based on a distance between the centroid and the each of the pitch patterns. Thereby, even when an inappropriate pattern is unexpectedly mixed into the selected pitch patterns, the fused pitch pattern can be generated by restraining adverse effects thereof.

Further, although the example applying the uniform weights to the overall prosody control unit has been disclosed in the embodiments described above, the manner is not limited thereto. For example, the manner may be such that the weighting method is altered only for an accented syllable, whereby weights different from one another are set for the respective sections of the pitch pattern, and then fusion thereof is carried out.

In the embodiment described above, the N pitch patterns are selected corresponding to the respective prosody control unit at the pattern selection step S101 in FIG. 4, but the manner of selection is not limited thereto. For example, the number of pitch patterns to be selected corresponding to the respective prosody control unit may be altered. More specifically, the number of pitch patterns to be selected can be adaptively determined depending on a certain factor, such as the cost value or the number of pitch patterns stored in the pitch pattern database.

Further, in the embodiment described above, pitch patterns are selected from pitch patterns whose pattern attribute information matches with the accent type and the number of syllables of the corresponding accent phrase, but the manner of selection is not limited thereto. For example, the manner may be such that, when such matching pitch patterns stored in the pitch pattern database are not present or are small in number, the pitch patterns are selected from pitch pattern candidates similar to one another.

Furthermore, in the embodiment described above, the examples using the information regarding the position in sentence in the attribute information are disclosed as the target cost in the event of selection by the pattern selecting unit 10, but there are no limitations thereto. For example, differences in various other items of information included in the attribute information are used by being digitized, or differences between the duration of the respective pitch patterns and the target duration may be used.

While the embodiment described above has been described with reference to the example using the pitch differences at the concatenation boundaries as the concatenation costs in the pattern selecting unit 10, the manner is not limited thereto. For example, differences in the gradient of pitch variation at the concatenation boundaries may be used.

Moreover, although in the embodiment described above, the sum of the costs, which is the sum of weighted costs of sub-cost functions, is used as the cost functions in the pattern selecting unit 10, the manner is not limited thereto. The cost function may be a function with sub-cost functions set to arguments.

In addition, in the embodiment described above, the estimation method for estimating the cost in the pattern selecting unit 10 has been described with reference to the example of calculating the cost functions, but the method is not limited thereto. For example, the cost may be alternatively estimated by using a well-known statistical method, such as the quantification method type I, from the language attribute information and the pattern attribute information.

Further, in the embodiment described above, the patterns are each expanded to meet the longest one of the pitch patterns corresponding to the syllable when scaling the lengths of the plurality of pitch patterns in step S121, but the manner is not limited thereto. The lengths may be scaled to meet a practically necessary length in accordance with the duration (111) in such a manner that, for example, the process is combined with the process of the pattern scaling unit 12, or the sequence thereof is interchanged. Alternately, pitch patterns are stored in advance into the pitch pattern storing unit 16 after, for example, the lengths corresponding to the syllable are preliminarily normalized.

Furthermore, the embodiment described above includes the process by the offset estimation unit 13 to estimate the offset value (104) equivalent to the average height of the overall pitch patterns and the process by the offset control unit 14 to move the pitch pattern the parallel to the frequency axis on the basis of the estimated offset value. However, these processes are not necessary in all cases. For example, the heights of the pitch patterns stored in the pitch pattern storing unit 16 may be used as they are. Further, even in the case where offset control is carried out, the processes may be executed before the process by the pattern scaling unit 12 or before the process by the pattern fusing unit 11 or may be executed concurrent with the pattern selection by the pattern selecting unit 10, as processing timing.

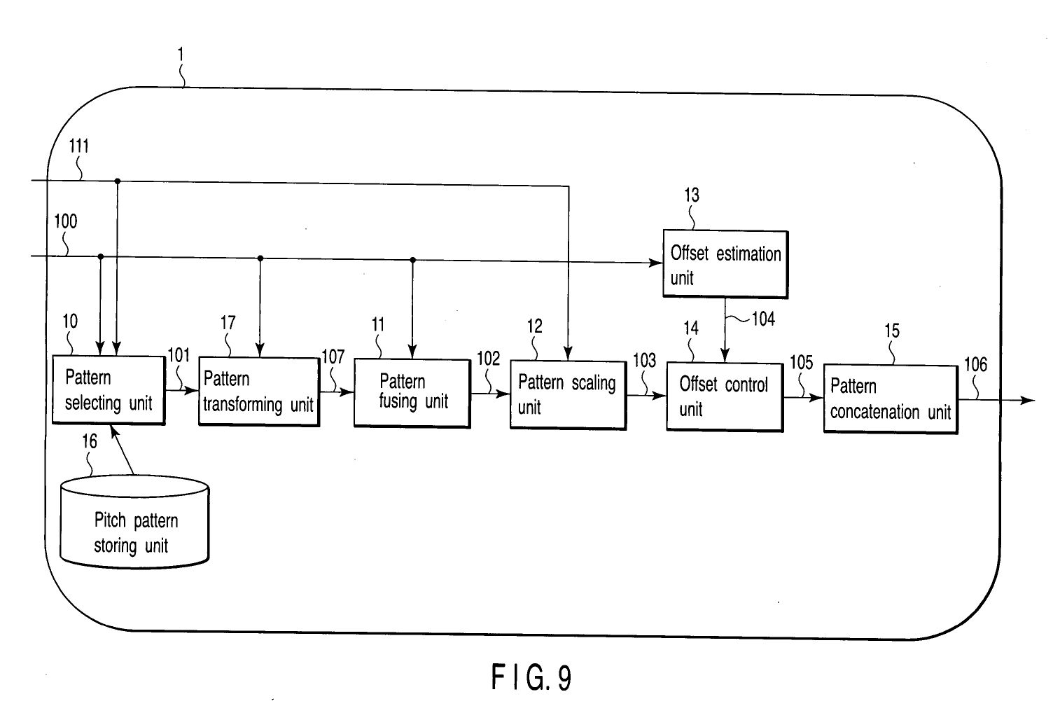

As shown in FIG. 9, the pitch pattern generating unit 1 may also include a pattern transforming unit 17 inserted between the pattern selecting unit 10 and the pattern fusing unit 11. In the pitch pattern generating unit 1 of FIG. 9 thus configured, transformed pitch patterns (107) are generated in such a manner that the pattern transforming unit 17 performs necessary transformations to respective ones of the plurality of pitch patterns (101) selected by the pattern selecting unit 10. Then, the transformed pitch patterns (107) are fused by the pattern fusing unit 11. The transformations of the pitch patterns are performed based on the relationships between the language attribute information (100) and the pattern attribute information of the respective selected pitch patterns. The pattern transforming unit 17 performs a transforming process including, for example, a smoothing process (microprosody correction process) and pitch pattern expansion/contraction process. More specifically, when, for example, the target phoneme type is different from the phoneme of the selected pitch pattern, the smoothing process to eliminate effects of microprosodies occurring in the form of micro-pitch variation specific to the phoneme. In addition, when, for example, the desired accent position or number of syllables in the target prosody control unit are different from the accent position or number of syllables in the selected pitch pattern, the selected pitch pattern is expanded and/or contracted in order to eliminate mismatch between the target accent position or number of syllables in the prosody control unit and the accent position or number of syllables in the selected pitch pattern.

The respective functions described above can be implemented by using hardware.

The method described in the present embodiment can also be distributed in the form of a program. In this case, the program may be stored in any one of, for example, magnetic disks, optical disks, and semiconductor memories.

Further, the respective functions described above can be implemented by being described in the form of software and by being executed by a computer having appropriate mechanisms.

What is claimed is:

1. A pitch pattern generating method comprising:
preparing a memory to store a plurality of pitch patterns each extracted from natural speech, and pattern attribute information corresponding to the pitch patterns;
inputting language attribute information obtained by analyzing a text including prosody control units;
selecting, from the pitch patterns stored in the memory, a group of pitch patterns corresponding to each of the prosody control units based on the language attribute information, to obtain a plurality of groups corresponding to the prosody control units respectively;
generating a new pitch pattern corresponding to the each of prosody control units by fusing pitch patterns of the group, to obtain a plurality of new pitch patterns corresponding to the prosody control units respectively; and
generating a pitch pattern corresponding to the text based on the new pitch patterns.

2. The pitch pattern generating method according to claim 1, wherein selecting includes:
estimating a degree of difference between each of the pitch patterns stored in the memory and a desired pitch variation corresponding to the each of the prosody control units, to obtain a plurality of degrees corresponding to the pitch patterns respectively; and
selecting the group, based on the degrees.

3. The pitch pattern generating method according to claim 1, wherein generating the new pitch pattern generates the new pitch pattern by calculating weighted sum of the pitch patterns of the group.

4. The pitch pattern generating method according to claim 3, wherein generating the new pitch pattern includes:
determining a weight which corresponds to each of the pitch patterns of the group in order to fuse the pitch patterns of the group, based on relationship between the language attribute information and the pattern attribute information which corresponds to the each of the pitch patterns of the group.

5. The pitch pattern generating method according to claim 3, wherein generating the new pitch pattern includes:
calculating a centroid of the pitch patterns of the group; and
determining a weight which corresponds to each of the pitch patterns of the group in order to fuse the pitch patterns of the group, based on a distance between the centroid and the each of the pitch patterns of the group.

6. The pitch pattern generating method according to claim 1, wherein generating the new pitch pattern includes:
transforming each of the pitch patterns of the group based on relationship between the language attribute information and the pattern attribute information which corresponds to the each of the pitch patterns of the group, to obtain a plurality of transformed pitch patterns corresponding to the pitch patterns of the group respectively; and
fusing the transformed pitch patterns, to generate the new pitch pattern.

7. The pitch pattern generating method according to claim 6, wherein transforming transforms the each of the pitch patterns of the group with a microprosody correction process.

8. The pitch pattern generating method according to claim 6, wherein transforming transforms the each of the pitch patterns of the group by expanding and/or contracting the each of the pitch patterns of the group in order to eliminate a mismatch between a target accent position in the each of the prosody control units and an accent position in the each of the pitch patterns of the group.

9. The pitch pattern generating method according to claim 6, wherein transforming transforms the each of the pitch patterns of the group by expanding and/or contracting the each of the pitch patterns of the group in order to eliminate a mismatch between a target number of syllables in the each of the prosody control units and a number of syllables in the each of the pitch patterns of the group.

10. The pitch pattern generating method according to claim 1, wherein generating the pitch pattern corresponding to the text includes:
transforming each of the new pitch patterns based on an offset value corresponding to an overall pitch level of a corresponding one of the prosody control units.

11. The pitch pattern generating method according to claim 1, wherein the memory stores the pitch patterns quantized.

12. The pitch pattern generating method according to claim 1, wherein the memory stores the pitch patterns approximated.

13. A pitch pattern generating apparatus comprising:
a memory to store a plurality of pitch patterns each extracted from natural speech, and pattern attribute information corresponding to the pitch patterns;
an input unit configured to input language attribute information obtained by analyzing a text including prosody control units;
a selecting unit configured to select, from the pitch patterns stored in the memory, a group of pitch patterns corresponding to each of the prosody control units based on the language attribute information, to obtain a plurality of groups corresponding to the prosody control units respectively;
a first generating unit configured to generate a new pitch pattern corresponding to the each of prosody control units by fusing pitch patterns of the group, to obtain a plurality of new pitch patterns corresponding to the prosody control units respectively; and
a second generating unit configured to generate a pitch pattern corresponding to the text based on the new pitch patterns.

14. The pitch pattern generating apparatus according to claim 13, wherein the selecting unit includes:
an estimating unit configured to estimate a degree of difference between each of the pitch patterns stored in the memory and a desired pitch variation corresponding to the each of the prosody control units, to obtain a plurality of degrees corresponding to the pitch patterns respectively; and wherein the selecting unit selects the group, based on the degrees.

15. The pitch pattern generating apparatus according to claim 13, wherein the first generating unit generates the new pitch pattern by calculating weighted sum of the pitch patterns of the group.

16. The pitch pattern generating apparatus according to claim 13, wherein the first generating unit includes:
a transforming unit configured to transform each of the pitch patterns of the group based on relationship between the language attribute information and the pattern attribute information which corresponds to the each of the pitch patterns of the group, to obtain a plurality of transformed pitch patterns corresponding to the pitch patterns of the group respectively; and
a fusing unit configured to fuse the transformed pitch patterns, to generate the new pitch pattern.

17. The pitch pattern generating apparatus according to claim 13, wherein the second generating unit includes:
a transforming unit configured to transform each of the pitch patterns of the group based on an offset value corresponding to an overall pitch level of a corresponding one of the prosody control units.

18. The pitch pattern generating apparatus according to claim 13, wherein the memory stores the pitch patterns each quantized.

19. The pitch pattern generating apparatus according to claim 13, wherein the memory stores the pitch patterns approximated 20. A pitch pattern generating program product comprising instructions of:
preparing a memory to store a plurality of pitch patterns each extracted from natural speech, and pattern attribute information corresponding to the pitch patterns;
inputting language attribute information obtained by analyzing a text including prosody control units;
selecting, from the pitch patterns stored in the memory, a group of pitch patterns corresponding to each of the prosody control units based on the language attribute information, to obtain a plurality of groups corresponding to the prosody control units respectively;
generating a new pitch pattern corresponding to the each of prosody control units by fusing pitch patterns of the group, to obtain a plurality of new pitch patterns corresponding to the prosody control units respectively; and
generating a pitch pattern corresponding to the text based on the new pitch patterns.
